(19) United States
(12) Patent Application Publication
(10) Pub. No.: US 2009/0105947 A1
(43) Pub. Date: Apr. 23, 2009

(54) Computer System and Method for Providing Warnings to a User for Completing Tasks From the Task List

(76) Inventors: Anna Nachesa, Haarlem (NL); Ana Henneberke, Amsterdam (NL)

Correspondence Address: HARNESS, DICKEY & PIERCE, P.L.C., P.O. BOX 8910, RESTON, VA, 20195, US

(21) Appl. No.: 12/225,731

(22) PCT Filed: Jun. 27, 2006
(86) PCT No.: PCT/NL2006/050147

§ 371 Date: Sep. 29, 2008

(51) Int. Cl. G01C 21/32

(52) U.S. Cl. 701/209; 701/211

(57) ABSTRACT

A computer system is disclosed, including a processor unit, arranged to communicate with a memory and a positioning device, the memory including a map database and a task list, the task list including at least one task, where at least one of the at least one task has a location indicator associated therewith. The positioning device is arranged to provide information about a position. In at least one embodiment, the computer system is arranged to compute an estimated travel parameter from a current position to a location indicator associated with one of the at least one task using the map database, to compare the estimated travel parameter to a threshold value, and to generate a warning signal if the computed estimated travel parameter is smaller than the threshold value.

### TECHNICAL FIELD

The present invention relates to a computer system being arranged to comprise a map database and a task list, arranged to provide warnings to a user for completing tasks from the task list. The invention further relates to a vehicle, comprising such a computer system, a method for providing warnings to a user for completing tasks from the task list, a computer program and a data carrier.

### STATE OF THE ART

Prior art navigation devices based on GPS (Global Positioning System) are well known and are widely employed as in-car navigation systems. Such a GPS based navigation device relates to a computing device which in a functional connection to an external (or internal) GPS receiver is capable of determining its global position. Moreover, the computing device is capable of determining a route between start and destination addresses, which can be input by a user of the computing device. Typically, the computing device is enabled by software for computing a “best” or “optimum” route between the start and destination address locations from a map database. A “best” or “optimum” route is determined on the basis of predetermined criteria and need not necessarily be the fastest or shortest route.

The navigation device may typically be mounted on the dashboard of a vehicle, but may also be formed as part of an on-board computer of the vehicle or car radio. The navigation device may also be (part of) a hand-held system, such as a PDA or a laptop.

By using positional information derived from the GPS receiver, the computing device can determine at regular intervals its position and can display the current position of the vehicle to the user. The navigation device may also comprise memory devices for storing map data and a display for displaying a selected portion of the map data.

Also, it can provide instructions how to navigate the determined route by appropriate navigation directions displayed on the display and/or generated as audible signals from a speaker (e.g. ‘turn left in 100 m’). Graphics depicting the actions to be accomplished (e.g. a left arrow indicating a left turn ahead) can be displayed in a status bar and also be superimposed upon the applicable junctions/turnings etc. in the map itself.

It is known to enable in-car navigation systems to allow the driver, whilst driving in a car along a route calculated by the navigation system, to initiate a route re-calculation. This is useful where the vehicle is faced with construction work or heavy congestion.

It is also known to enable a user to choose the kind of route calculation algorithm deployed by the navigation device, selecting for example from a ‘Normal’ mode and a ‘Fast’ mode (which calculates the route in the shortest time, but does not explore as many alternative routes as the Normal mode).

It is also known to allow a route to be calculated with user defined criteria; for example, the user may prefer a scenic route to be calculated by the device. The device software would then calculate various routes and weigh more favourably those that include along their route the highest number of points of interest (known as POIs) tagged as being for example of scenic beauty.

U.S. Pat. No. 6,266,612 B1 describes a mobile computer system arranged to receive positioning information corresponding to its geographical location, for instance by means of a GPS satellite, a GLONASS satellite or a pseudolite (pseudo satellite). The mobile computer system may further comprise or have access to a database comprising a task list. The mobile computer system indexes the database based on the positioning information when the positioning information indicates that the mobile computer is within a predetermined radius R of a geographical position that allows completion of a task from the task list. In that case, the mobile computer system is arranged to provide a warning.

It is an object to provide a computer system that is arranged to generate more efficient warnings.

### SHORT DESCRIPTION

An aspect of the claimed invention provides a computer system comprising a processor unit, the processor unit being arranged to communicate with a memory and a positioning device,

the memory being arranged to comprise a map database and a task list, the task list being arranged to comprise at least one task, where at least one of the at least one task has a location indicator associated with it,

the positioning device being arranged to provide information about a position, characterized in, that the computer system is arranged to

a) compute an estimated travel parameter from a current position as measured by the positioning device to a location indicator associated with one of the at least one task using the map database,
b) compare the estimated travel parameter to a predetermined threshold value, and
c) generate a warning signal if the estimated travel parameter is smaller than the predetermined threshold value. Such a computer system is arranged to provide a user with a warning about a task that is to be completed only if the task can be completed relatively easily, i.e. compared with a predetermined threshold value.

According to an embodiment the map database comprises address information and points of interest, the point of interest being divided in POI categories, and wherein each location indicator may be one of an address and a point of interest (POI) category.

According to an embodiment, in case the location indicator associated with a task is a POI category, the computer system is arranged to perform a) by:

a1) selecting a number of POI's from the map database from the POI category using a POI-selection algorithm,
a2) computing estimated travel parameters from the current position to each of the selected POI's, and
a3) selecting the POI of the number of POI's having the smallest estimated travel parameter.

According to an embodiment the estimated travel parameter is computed by computing a route from the current position to the location indicator using navigation software.

According to an embodiment the estimated travel parameter is computed according to predetermined criteria: such as shortest route, fastest route.

According to an embodiment the estimated travel parameter is computed taking into account current traffic information.

According to an embodiment each of the at least one task has a threshold value associated with it, and is performed by comparing the estimated travel parameter to the predetermined threshold value associated with the relevant task.

According to an embodiment each task has a time associated with it.

According to an embodiment the predetermined threshold value varies.

According to an embodiment the predetermined threshold value varies depending on the time associated with the task. For instance, the predetermined threshold may increase when the time associated with the task is approaching.

According to an embodiment the estimated travel parameter is one of an estimated travel time and an estimated travel distance.

According to an embodiment the predetermined threshold value is one of a time threshold and a distance threshold.

According to an embodiment the warning signal may be an acoustic warning signal, a spoken warning message or the like provided using a speaker.

According to an embodiment the warning signal is a warning icon displayed on a display.

According to an embodiment the warning icon is a virtual button, which, when pressed, triggers the computer system to provide navigation instructions to navigate a user to the relevant location indicator.

According to an embodiment the computer system may be any one of the following: a navigation device, a mobile telephone, a personal digital assistant, a laptop.

According to an embodiment the computer system is arranged to register completion of a task.

According to an embodiment the computer system is a navigation device.

An aspect of the claimed invention provides a vehicle, comprising a computer system according to the above. Such a vehicle may be a car, motorcycle, bicycle, etc.

An aspect of the claimed invention provides a method, comprising:
providing a map database and a task list, the task list being arranged to comprise at least one task, where at least one of the at least one task has a location indicator associated with it,
providing a positioning device being arranged to provide information about a position, characterized in, that the method comprises the following:
   a) compute an estimated travel parameter from a current position as measured by the positioning device to a location indicator associated with one of the at least one tasks using the map database,
   b) compare the estimated travel parameter to a predetermined threshold value, and
   c) generate a warning signal if the estimated travel parameter is smaller than the predetermined threshold value.

An aspect of the claimed invention provides a computer program, when loaded on a computer arrangement, arranged to perform the method described above.

An aspect of the claimed invention provides a data carrier, comprising a computer program according to the above.

### SHORT DESCRIPTION OF THE DRAWINGS

Embodiments of the invention will now be described, by way of example only, with reference to the accompanying schematic drawings in which corresponding reference symbols indicate corresponding parts, and in which:

FIG. 1 schematically depicts a schematic block diagram of a navigation device,

FIG. 2 schematically depicts a schematic view of a navigation device,

FIG. 3 schematically depicts a task list according to an embodiment,

FIGS. 4a and 4b schematically depict flow diagrams of different embodiments,

FIG. 5 schematically depicts a task list according to an embodiment,

FIG. 6 schematically depicts a flow diagram according to an embodiment,

FIG. 7 schematically depicts a flow diagram according to a further embodiment.

### DETAILED DESCRIPTION

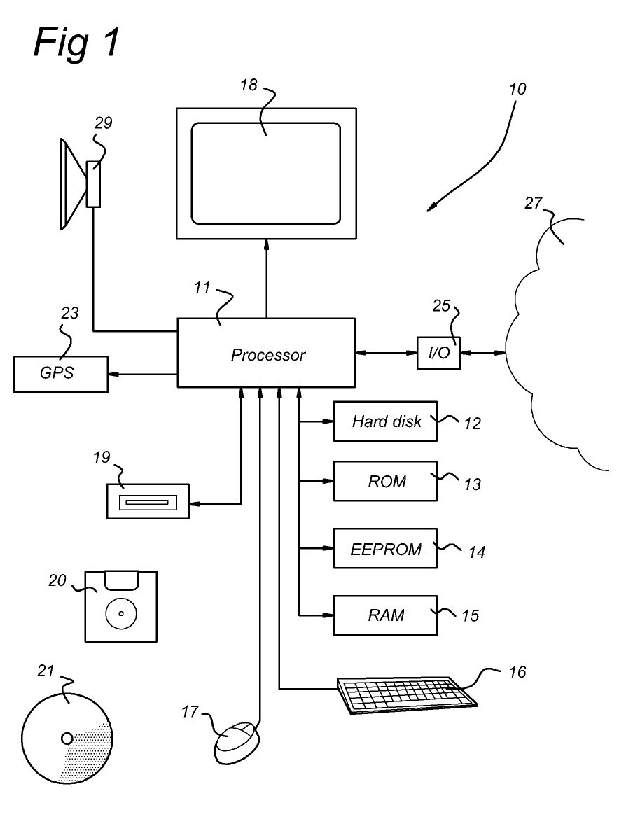

FIG. 1 shows a schematic block diagram of an embodiment of a navigation device 10, comprising a processor unit 11 for performing arithmetical operations. The processor unit 11 is arranged to communicate with memory units that store instructions and data, such as a hard disk 12 or another external storage media, a Read Only Memory (ROM) 13, Electrically Erasable Programmable Read Only Memory (EEPROM) 14 and a Random Access Memory (RAM) 15. The memory units may comprise map data. This map data may be two dimensional map data (latitude and longitude), but may also comprise a third dimension (height). The map data may further comprise additional information such as information about various types of points of interest (POI). Examples of POIs include, but are not limited to, petrol/gas stations, shops, tourist attractions et cetera. The POIs location could be static (this is the case for most POIs) or dynamic. For instance a POI may be an indication of the current position of an object, such as an other navigation device 10, where the other navigation device 10 is a moving object, the current position of which is exchanged via a network, connecting different navigation devices 10. A POI may also be a dynamic POI because it only exists temporarily, for instance a POI referring to the location of an event such as a pop concert.

The map data may also comprise information about the shape of buildings and objects along the road. There could also be other map augmentations, for example, weather conditions.

The processor unit 11 may also be arranged to communicate with one or more input devices, such as a keyboard 16 and a mouse 17. The keyboard 16 may for instance be a virtual keyboard, provided on a display 18, being a touch screen. The processor unit 11 may further be arranged to communicate with one or more output devices, such as display 18, a speaker 29 and one or more reading units 19 to read for instance floppy disks 20 or CD ROM's or DVD's 21, or another storage media available. The display 18 could be a conventional computer display (e.g. LCD) or could be a projection type display, such as the head up type display used to project instrumentation data onto a car windscreen or windshield. The display 18 may also be a display arranged to function as a touch screen, which allows the user to input instructions and/or information by touching the display 18 with his finger.

The speaker 29 may be formed as part of the navigation device 10. In case the navigation device 10 is used as an in-car navigation device, the navigation device 10 may use speakers of the car radio, the board computer and the like.

The processor unit 11 may further be arranged to communicate with a positioning device 23, such as a GPS receiver, that provides information about the position of the navigation device 10 or positioning device 23 itself. According to this embodiment, the positioning device 23 is a GPS based positioning device 23. However, it will be understood that the navigation device 10 may implement any kind of positioning sensing technology and is not limited to GPS. It can hence be implemented using other kinds of GNSS (global navigation satellite system) such as the European Galileo system. Equally, it is not limited to satellite based location/velocity systems but can equally be deployed using ground-based beacons or any other kind of system that enables the device to determine its geographical location.

However, it should be understood that there may be provided more and/or other memory units, input devices and read devices known to persons skilled in the art. Moreover, one or more of them may be physically located remote from the processor unit 11, if required. The processor unit 11 is shown as one box, however, it may comprise several processing units functioning in parallel or controlled by one main processor that may be located remote from one another, as is known to persons skilled in the art.

The navigation device 10 is shown as a computer system, but can be any signal processing system with analog and/or digital and/or software technology arranged to perform the functions discussed here. It will be understood that although the navigation device 10 is shown in FIG. 1 as a plurality of components, the navigation device 10 may be formed as a single device.

The navigation device 10 may use navigation software, such as navigation software from TomTom B.V. called Navigator. Navigator software may run on a PDA device not specifically created for navigation purposes, such as the Compaq iPaq running under Windows CE or Nokia communicator phone running under Symbian OS, and these devices may have an integral GPS receiver 23 or use an external GPS receiver, or on a specialized navigation PDA device such as TomTom GO. The combined PDA and GPS receiver system is designed to be used as an in-vehicle navigation system. The embodiments may also be implemented in any other arrangement of navigation device 10, such as one with an integral GPS receiver/computer/display, or a device designed for non-vehicle use (e.g. for walkers) or vehicles other than cars (e.g. aircraft).

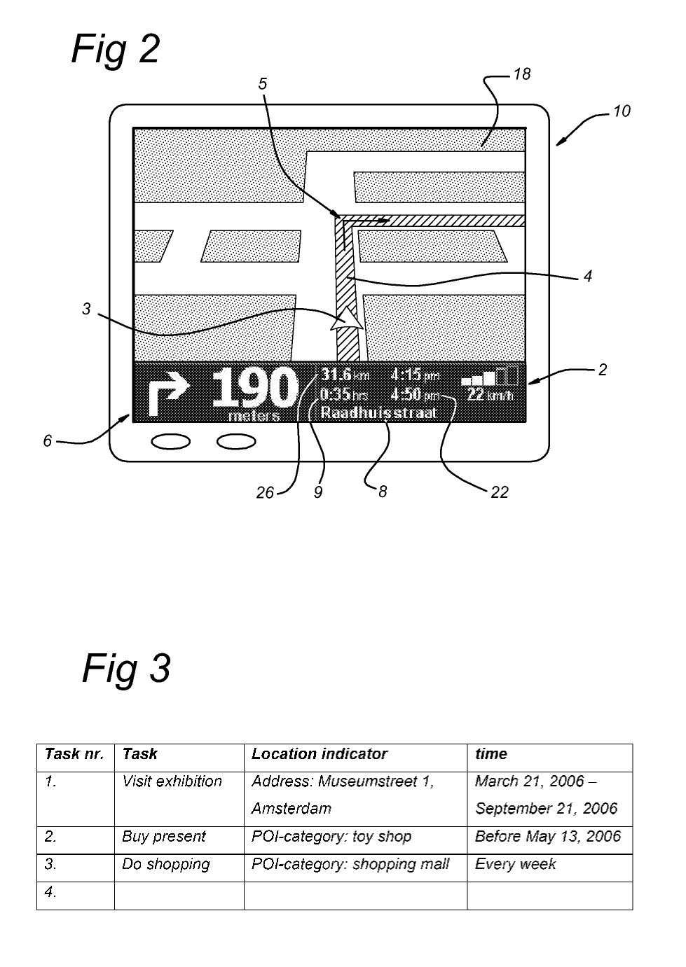

FIG. 2 depicts a navigation device 10 as described above.

Navigator software, when running on the navigation device 10, causes a navigation device 10 to display a normal navigation mode screen at the display 18, as shown in FIG. 2. This view may provide driving instructions using a combination of text, symbols, voice guidance and a moving map. Key user interface elements are the following: a 3-D map occupies most of the screen. It is noted that the map may also be shown as a 2-D map.

The map shows the position of the navigation device 10 and its immediate surroundings, rotated in such a way that the direction in which the navigation device 10 is moving is always “up”. Running across the bottom quarter of the screen may be a status bar 2. The current location of the navigation device 10 (as the navigation device 10 itself determines using conventional GPS location finding) and its orientation (as inferred from its direction of travel) is depicted by a position arrow 3. A route 4 calculated by the device (using route calculation algorithms stored in memory devices 11, 12, 13, 14, 15 as applied to map data stored in a map database in memory devices 11, 12, 13, 14, 15) is shown as darkened path. On the route 4, all major actions (e.g. turning corners, crossroads, roundabouts etc.) are schematically depicted by arrows 5 overlaying the route 4. The status bar 2 also includes at its left hand side a schematic icon depicting the next action 6 (here, a right turn). The status bar 2 also shows the distance to the next action (i.e. the right turn—here the distance is 190 meters) as extracted from a database of the entire route calculated by the device (i.e. a list of all roads and related actions defining the route to be taken). Status bar 2 also shows the name of the current road 8, the estimated time before arrival 9 (here 35 minutes), the actual estimated arrival time 22 (4.50 pm) and the distance to the destination 26 (31.6 Km). The status bar 2 may further show additional information, such as GPS signal strength in a mobile-phone style signal strength indicator.

As already mentioned above, the navigation device may comprise input devices, such as a touch screen, that allows the users to call up a navigation menu (not shown). From this menu, other navigation functions can be initiated or controlled. Allowing navigation functions to be selected from a menu screen that is itself very readily called up (e.g. one step away from the map display to the menu screen) greatly simplifies the user interaction and makes it faster and easier. The navigation menu includes the option for the user to input a destination.

The actual physical structure of the navigation device 10 itself may be fundamentally no different from any conventional handheld computer, other than the integral GPS receiver 23 or a GPS data feed from an external GPS receiver. Hence, memory devices 12, 13, 14, 15 store the route calculation algorithms, map database and user interface software; a processor unit 12 interprets and processes user input (e.g. using a touch screen to input the start and destination addresses and all other control inputs) and deploys the route calculation algorithms to calculate the optimal route. ‘Optimal’ may refer to criteria such as shortest time or shortest distance, or some other user-related factors.

More specifically, the user inputs his start position and required destination into the navigation software running on the navigation device 10, using the input devices provided, such as a touch screen 18, keyboard 16 etc. A user may for instance input a destination by typing a destination address or selecting a (static/dynamic) POI as a destination.

The user then selects the manner in which a travel route is calculated: various modes are offered, such as a ‘fast’ mode that calculates the route very rapidly, but the route might not be the shortest; a ‘full’ mode that looks at all possible routes and locates the shortest, but takes longer to calculate etc. Other options are possible, with a user defining a route that is scenic—e.g. passes the most POI (points of interest) marked as views of outstanding beauty, or passes the most POI of possible interest to children or uses the fewest junctions etc.

The navigation device 10 may further comprise an input-output device 25 that allows the navigation device to communicate with remote systems, such as other navigation devices 10, personal computers, servers etc., via network 27. The network 27 may be any type of network 27, such as a LAN, WAN, Blue tooth, internet, intranet and the like. The communication may b wired or wireless. A wireless communication link may for instance use RF-signals (radio frequency) and a RF-network.

Roads themselves are described in the map database that is part of navigation software (or is otherwise accessed by it) running on the navigation device 10 as lines—i.e. vectors (e.g. start point, end point, direction for a road, with an entire road being made up of many hundreds of such sections, each uniquely defined by start point/end point direction parameters). A map is then a set of such road vectors, plus points of interest (POIs), plus road names, plus other geographic features like park boundaries, river boundaries etc, all of which are defined in terms of vectors, plus additional information that may change with time (traffic jams, weather conditions, positions of other persons etc). All map features (e.g. road vectors, POIs etc.) are defined in a co-ordinate system that corresponds or relates to the GPS co-ordinate system, enabling a device's position as determined through a GPS system to be located onto the relevant road shown in a map.

The map database may comprise address information, such as road names, house numbers, postal or zip codes, city names etc.

Route calculation uses complex algorithms that are part of the navigation software. The algorithms are applied to score large numbers of potential different routes. The navigation software then evaluates them against the user defined criteria (or device defaults), such as a full mode scan, with scenic route, past museums, and no speed camera. The route which best meets the defined criteria is then calculated by the processor unit 11 and then stored in a database in the memory devices 12, 13, 14, 15 as a sequence of vectors, road names and actions to be done at vector end-points (e.g. corresponding to pre-determined distances along each road of the route, such as after 100 meters, turn left into street x).

The navigation device 10 may also be incorporated in any kind of computer system, such as a mobile telephone, PDA (personal digital assistant) or laptop. It will be understood that the term navigation device 10 as used in this text, may also relate to a navigation device 10 without a display 18. Such a navigation device 10 may be arranged to provide audible instructions only, and may for instance be used by persons with impaired vision.

### Embodiment 1A

According to an embodiment, there is provided a navigation device 10 as for instance described above. The navigation device 10 may comprise a task list as schematically shown in FIG. 3 stored in the memory 12, 13, 14, 15. This task list may be inputted by a user using input devices as for instance described above: keyboard 16, mouse 17, display 18, being a touch screen as will be understood by a skilled person. Alternatively, the input may be done using audio input, as will be understood by a skilled person.

The task list may comprise a number of tasks, such as ‘visit museum’, ‘buy present’ and ‘do shopping’. Associated with the tasks, the task list comprises location indicators, such as an address: ‘Museumstreet 1, Amsterdam’ or a PO category: ‘toy shop’ or ‘shopping mall’.

The POI category may also relate to a certain subject or personal interest of the user, such as for instance “photography”, “dancing”, “music”, “collectibles”, “sports”, “painting”, “sculpture”, “cars”, “computers”, etc.

In order to organize all POI's and POI categories efficiently and to allow easy selection of an appropriate POI category for a user, some POI categories may comprise a number of POI's (e.g. the POI category “music store” may comprise a number of music stores), while other POI categories may comprise a plurality of POI categories (e.g. the POI category “music” may comprise the POI categories “music stores”, “pop concerts” and “dancing”). This allows the user to simply select a POI category that matches his/her interests.

It will be understood that by selecting such an interest, such as “music”, the user is constantly informed of music stores, pop concerts etc. that are near by. Since the POI's stored in the memory of the navigation device 10 may be dynamic POI's and may be updated on a regular basis, the user may be informed of events like pop concerts.

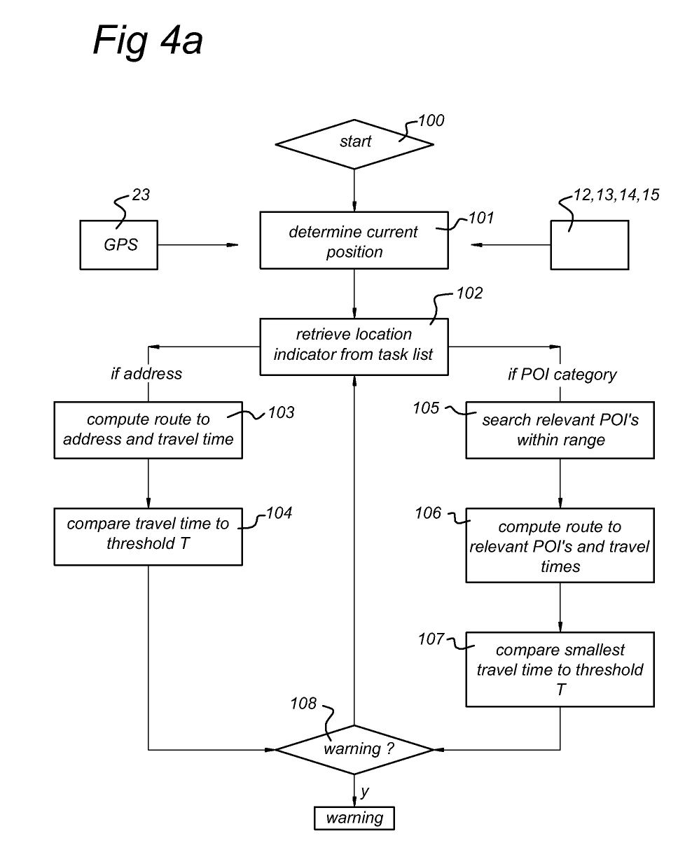

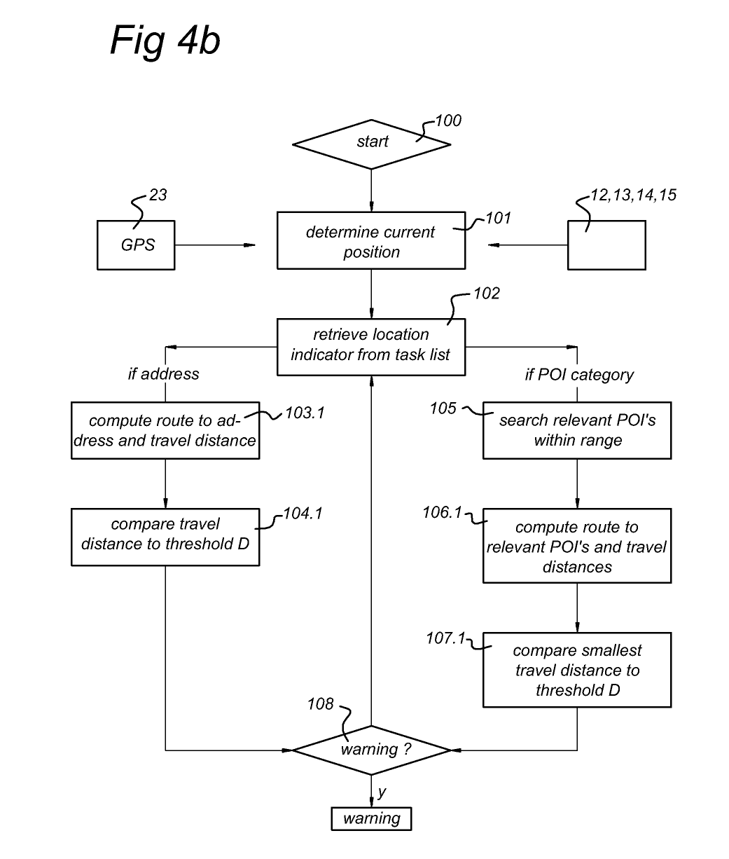

FIG. 4a schematically shows a flow chart of the actions as may be performed by the navigation device 10 according to an embodiment. The memory 12, 13, 14, 15 may comprise programming instructions that are readable and executable by the processor unit 11 instructing the processor unit 11 to perform the actions as presented in FIG. 4a.

In a first action 100, the processor unit 11 may start executing the flow chart. Action 100 may be triggered by a user, instructing the navigation device 10 to start execution. However, the navigation device 10 may also be programmed to start automatically, for instance when the navigation device 10 is switched on.

In a next action 101, the processor unit 11 determines the current position of the navigation device 10, for instance by receiving positional data from the positioning device 23, such as a GPS receiver, that provides information about the position of the navigation device 10, as described above. The processor unit 11 may instruct the positioning device 23 to perform a position measurement, but the positioning device 23 may also be arranged to continuously perform position measurements. In the latter case, the processor unit 11 may simply use the latest available position measurement.

In a next action 102, the processor unit 11 retrieves a first location indicator from the task list from memory 12, 13, 14, 15, for instance being an address: Museumstreet 1, Amsterdam. If the location indicator is an address, the process continues with action 103.

In action 103 a route is computed from the current position as determined in action 101 to the address retrieved from the task list in action 102. This route may be computed using any kind of navigation software known to a skilled person. The navigation device 10 may compute an optimal route (for instance the shortest route, or the fastest route) using the ‘Normal’ mode or a ‘Fast mode’ as described above.

When computing a route from the current position to the address associated with the task, also an estimated travel parameter, such as an estimated travel time is computed, as will be understood by a skilled person. Computing the estimated travel time may be done by taking into account the speed limits along the route. Computing the estimated travel time may further be done by taking into account current traffic information (traffic jams) etc. The estimated travel time may for instance be 15 minutes.

After an (optimal) route and associated estimated travel time are computed, in action 104, the travel time is compared with a time threshold T value, for instance stored in memory 12, 13, 14, 15. This time threshold T may be a predetermined time threshold T, as will be explained in more detail below. If the estimated travel time is bigger than the time threshold T, no warning signal is generated and no warning is provided to the user. If the estimated travel time is smaller than or equal to the time threshold T, a warning signal is generated and a warning is provided to the user. This is decided by the processor unit 11 in action 108.

After action 108, the process returns to action 102 in which it retrieves a next location indicator from the task list from memory 12, 13, 14, 15, for instance being a POI category: ‘toy shop’. In this case, the location indicator is a POI category, the process continues with action 105.

In action 105, relevant POI's are selected within a range R of the current position as determined in action 101. The range R may be a standard range R of for instance 5 kilometres stored in memory 12, 13, 14, 15. The range R may for instance be linked to the time threshold T as used in actions 104 and 107 (described below), where R is the threshold T divided by a certain maximum velocity vₘₐₓ of for instance 100 km/h.

However, according to an alternative, instead of selecting all relevant POI's within a range, also the 10 nearest relevant POI's may be selected. Of course any other suitable number may be used.

It will be understood that any suitable POI-selection algorithm may be used for performing action 105.

In a next action 106, routes are computed to these selected relevant POI's and their corresponding estimated travel times. The routes may be computed as described above, for instance with respect to action 103.

Next, in action 107, the smallest travel time is compared to the time threshold T, similar to action 104. After this, in action 108, it is determined whether or not a warning signal is generated.

Finally, the process returns to action 102, to retrieve a next location indicator from the task list. According to an embodiment, the process may only return to action 102 if no warning signal is generated, or after the user has ignored the warning. This is to prevent more than one warning signal being generated at the same time.

According to an embodiment, the process may return to action 101 instead of action 102, to determine an up-to-date current position. It will be understood that actions 101 and 102 may also be performed in reversed order: first action 102, then 101.

The process described here may be repeated until all location indicators from the task list have been used. After this, the process may start over again with the first location indicator, or may be arranged to wait a predetermined amount of time before starting again with the first location indicator in order to save computation time.

According to an embodiment the processor unit 11 may be arranged to start over again with the first location indicator when it is detected in action 101 that the navigation device 10 has moved by more than a predetermined distance of for instance 1 kilometre.

After action 108, there may be an option to mark the task for which the POI search was performed as finished or to delete the task. If all tasks in the task list are marked as finished or there are no tasks in the task list, the method according to for instance FIG. 4a may be switched off until again one or more entries are entered in the task list.

### Embodiment 1B

According to a further embodiment, of which a flow diagram is shown in FIG. 4b, instead of computing an estimated travel time T, an estimated travel distance D is computed. FIG. 4b is similar to FIG. 4a, except for actions 103, 104, 106 and 107, which are now replaced by actions 103.1, 104.1, 106.1 and 107.1.

In action 103.1 a route is computed from the current position as determined in action 101 to the address retrieved from the task list in action 102. This route may be computed using any kind of navigation software known to a skilled person. The navigation device 10 may compute an optimal route (for instance the shortest route, or the fastest route) using the ‘Normal’ mode or a ‘Fast mode’ as described above.

When computing a route from the current position to the address associated with the task, also an estimated travel parameter, such as an estimated travel distance is computed, as will be understood by a skilled person. Computing the estimated travel distance may be done in a way known to a skilled person. The estimated travel distance may for instance be 10 km.

After an (optimal) route and associated estimated travel distance are computed, in action 104.1, the travel time is compared with a distance threshold D value, for instance stored in memory 12, 13, 14, 15. This distance threshold D may be a predetermined distance threshold D, as will be explained in more detail below. If the estimated travel time is bigger than the distance threshold D, no warning signal is generated and no warning is provided to the user. If the estimated travel time is smaller than or equal to the distance threshold D, a warning signal is generated and a warning is provided to the user. This is decided by the processor unit 11 in action 108.

It will be understood that similar modifications may be made to actions 106 and 107, as is shown in FIG. 4b by actions 106.1 and 107.1.

In general, an estimated travel parameter is computed in action 103, 103.1, 106, 106.1, which may for instance be an estimated travel time T or an estimated travel distance D. This estimated travel parameter is then compared to a threshold, which may be a time threshold T or a distance threshold D.

### Threshold

In actions 104 and 107 described above, an estimated travel parameter is compared to a threshold T, D to determine whether or not to generate a warning signal and provide a warning to the user. This threshold T, D may be a predetermined threshold T, D of for instance 15 minutes or 10 kilometres.

According to an embodiment, a task specific threshold Tᵢ, Dᵢ, may be inputted by a user when adding a new task to the task list. The navigation device 10 may be arranged to ask the user to enter the task specific threshold Tᵢ, Dᵢ. This provides the user with the option to store different task specific thresholds Tᵢ, Dᵢ for different tasks.

The task list may further comprise a time column, specifying when a task needs to be performed. For instance, the task ‘Visit museum’ may have the following time associated with it: ‘Mar. 21, 2006-Sep. 21, 2006’. This may be useful in case the user wants to visit an exhibition at the museum that is only opened during the indicated time window. The task ‘buy present’ may have the following time associated with it: ‘before May 13, 2006’, for instance in case the present is for a birthday party taking place May 13, 2006. Furthermore, the task ‘Do shopping’ may have a time associated with it: ‘Every week’, as shopping needs to be done every week.

According to an embodiment, the threshold T, D may depend on the specified time. For instance, the distance threshold Dᵢ for visiting the museum may increase from for instance an initial 5 km to 100 km during the time window ‘Mar. 21, 2006-Sep. 21, 2006’ to make sure the user is provided with a warning within the time window.

According to a further embodiment, the navigation device 10 may be arranged to generate a warning signal and provide a warning to the user irrespective of the current location of the navigation device 10, when the final deadline of a certain task is approaching.

### Warning Signal

The warning may be a warning icon displayed on the display 18, for instance comprising a text: “Task: Visit exhibition. Estimated travel time: 15 minutes”. This warning icon may be a virtual button, providing the user with the option to accept the warning or to ignore the warning. When accepted, the navigation device 10 is triggered to navigate the user to the address for instance according to the route previously computed. When the user ignores the warning, the navigation device 10 may be triggered to ignore this task for a predetermined time, in order to prevent warnings being provided repeatedly.

The warning icon may further provide the user with the option to request further information, for instance about the type of POI, availability of prices, opening hours etc.

The warning may of course also be provided with by an acoustic warning signal, a spoken warning message or the like provided using speaker 29.

### Register Completion of Task

The navigation device 10 may further be arranged to register when a task is completed, for instance when a warning icon is accepted, or when the navigation device 10 senses using positioning device 23 that a location associated with a task is indeed visited, or when the user manually sets the task status to completed. As discussed above, there may be an option to mark the task for which the POI search was performed as finished or to delete the task.

### Adding New Tasks

Different ways may be conceived for adding new tasks to the task list. According to an embodiment, the navigation device 10 may comprise a set of predefined tasks for particular POI's and/or POI-categories the user may choose from in order to add tasks to the task list. Of course, the user may also add new tasks to this set of predefined tasks. According to this embodiment, the user may add a new task to the task list by selecting a task from the set of predefined tasks and the user only needs to input a relevant time.

### Order of Completing Tasks

According to a further possibility, in case there are several tasks in the task list and several POIs where these tasks may be performed, the POIs may be selected that are situated in the most optimal way for the user. For example, in such a way that it would require minimum travel time and/or minimum expenses, provided that the navigation device 10 has a way to estimate these (examples: toll roads, parking charges, traffic jams). Also the order in which the tasks may be completed may be adjusted to reduce travel time.

So, the selection of a second POI may depend on the location of a selected first POI, in order to minimise travel time and expenses.

In case more than one warning is provided, the navigation device 10 may be arranged to compute an optimum order in which to complete the tasks, based on minimum travel time and/or minimum expenses.

### Advantages

The navigation device 10 as described in the embodiments provides a user with task reminders when he/she is near a location where it is possible to perform the task. This eliminates the need for the user to constantly check the task list and look through all the tasks that are to be done. It also reduces the possibility to forget about the task.

This is especially useful for tasks that may be not quite urgent, but need do be done eventually. Such tasks most users tend to forget and only realize they had to perform them when the opportunity is gone.

According to the embodiments described here, a warning signal is generated and a warning is provided to the user based on an estimated travel parameter, such as an estimated travel time or an estimated travel distance and not based on a distance as the crow flies. This provides the user with a warning including an accurate prediction of the amount of time it will take to complete the task. In case the warnings would be provided based on a distance as the crow flies, the user wouldn't have knowledge about the amount of time it will take to complete the task. A shopping mall at a distance of 500 metres next to a highway a user is driving on may take a 30 minute drive or a 40 kilometre drive, in case the highway doesn't have a direct exit to the shopping mall. According to the embodiments described here, no warning signal will be generated in this case, or, in case a warning signal is generated (depending on the threshold), the user would be given accurate information about the estimated travel time or distance.

Since the embodiments described here compute a (n optimal) route to a location relevant for completion of the task, the navigation device 10 may take into account current traffic conditions and the like. Therefore, the user may not be given a warning to complete a task in case there is a traffic jam on the route between the current location and the location the task is to be completed.

Also, according to the embodiments described here, the user is provided with the option to store several types of location indicators in the task list, such as for instance an address or a POI category. By providing the option to store a POI category being associated with a task to be completed, the user doesn't need to exactly specify where the task is to be completed. In case a present is to be purchased, the user only needs to specify the type of POI where an appropriate present may be purchased.

### Embodiment 2

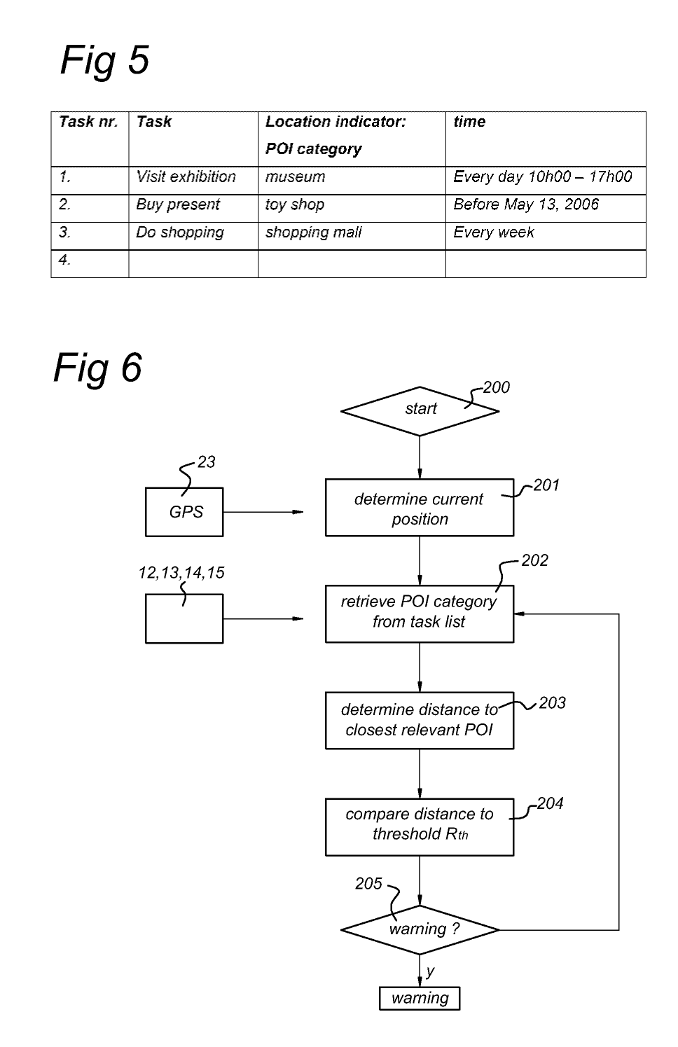

According to a further embodiment, a task list is provided according to FIG. 5, in which the location indicators are POI categories.

It is identified that using POI categories as location indicators, instead of addresses provides an advantageous embodiment. According to such an embodiment, the user doesn't need to specify an exact address where the task is to be completed. The navigation device 10 is provided with the functionality to search for relevant POI's where the task may be completed and that fulfil predetermined criteria, such as being within a certain range R′ from the current position, as will be explained in more detail below.

FIG. 6 schematically shows a flow chart of the actions as may be performed by the navigation device 10 according to this embodiment. The memory 12, 13, 14, 15 may comprise programming instructions that are readable and executable by the processor unit 11 instructing the processor unit 11 to perform the actions as presented in FIG. 6.

In a first action 200, the processor unit 11 may start executing the flow chart. Action 200 may be triggered by a user, instructing the navigation device 10 to start execution. However, the navigation device 10 may also be programmed to start automatically for instance when the navigation device 10 is switched on.

In a next action 201, the processor unit 11 determines the current position of the navigation device 10, for instance by receiving positional data from the positioning device 23, such as a GPS receiver, that provides information about the position of the navigation device 10, as described above. The processor unit 11 may instruct the positioning device 23 to perform a position measurement, but the positioning device may also be arranged to continuously perform position measurements. In the latter case, the processor unit 11 may simply use the latest available position measurement.

Next, in action 202, the navigation device 10 retrieves a first location indicator, being a POI category, from the task list stored in the memory 12, 13, 14, 15.

In a next action 203, the relevant POI is searched that is closest to the current position as determined in action 201. This may be done in several ways as will be understood by a skilled person. It may for instance be done by constructing a circle around the current position having a certain radius R₁ and search for all relevant POI's within the circle having radius R₁. In case more than one POI is found, the radius is decreased (e.g. R₂=R₁/2) and in case no POI is found, the radius R₁ is increased, for instance R₂=3*R₁/2). This iterative process of increasing and decreasing the circle may be done until just a single POI has been found, which may be considered the closest POI.

Once the closest, or the few closest, POI's are determined, the distance from the current position to this POI or these POI's is determined. This distance may be a distance ‘as the crow flies’ (in which case selecting just one POI suffices), but may also be an estimated travel distance (which may be computed as explained above with reference to embodiments 1a and 1b).

After this, the distance from the current position to the closest relevant POI as determined in action 204, is compared to a predetermined distance threshold Rₜₕ, for instance being 10 km. The distance threshold Rₜₕ may be a general threshold Rₜₕ stored in memory 12, 13, 14,15, but may also be a task specific threshold R_{th,1}, R_{th,2}, . . . .

If the distance is bigger than the threshold Rₜₕ, no warning signal is generated and no warning is provided to the user. If the distance is smaller than or equal to the threshold Rₜₕ, a warning signal is generated and a warning is provided to the user. This is determined in action 205.

Finally, the process returns to action 202, to retrieve a next location indicator from the task list. According to an embodiment, the process may only return to action 202 if no warning signal is generated, or when the user has ignored the warning. This is to prevent more than one warning being presented to the user at the same time.

According to an embodiment, the process may return to action 201 instead of action 202, to determine an up-to-date current position. It will be understood that actions 201 and 202 may also be performed reversed order: first action 202, then 201.

Of course, according to a variant of this second embodiment, in stead of selecting the closest relevant POI, the navigation device 10 may select the relevant POI that may be reached within the shortest travel time. This may be done by a process comprising actions 100, 101, 102, 105, 106, 107 and 108 as described with respect to FIG. 4a.

### Advantages

The navigation device 10 as described in the embodiments provides a user with task reminders when he/she is near a location where it is possible to perform the task. This eliminates the need for the user to constantly check the task list and look through all the tasks that are to be done. It also reduces the possibility to forget about the task.

This is especially useful for tasks that may be not quite urgent, but need do be done eventually. Such tasks most users tend to forget and only realize they had to perform them when the opportunity is gone.

Also, according to the embodiment described here, the user is provided with the option to store a POI category as a location indicator. By providing the option to store a POI category being associated with a task to be completed, the user doesn't need to exactly specify where the task is to be completed. In case a present is to be purchased, the user only needs to specify the type of POI where an appropriate present may be purchased.

### Embodiment 3

According to a further embodiment, the navigation device 10 may further be arranged to also use information about a planned route to remind a user of tasks that may be completed along a planned route. Therefore, a planned route as may be determined by navigation device 10 may be compared to the location indicators from the task list stored in memory 12, 13, 14, 15. This may for instance be done by comparing subsequent positions along the route, spaced at 100 meter intervals, with the location indicators.

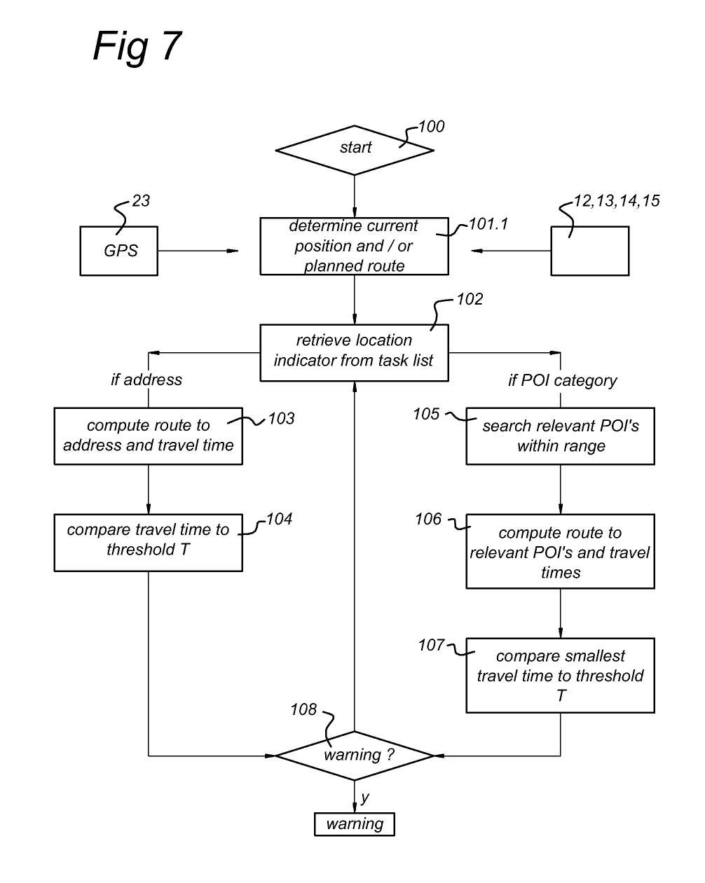

FIG. 7 shows a flow diagram according to such an embodiment. This flow diagram is similar to the flow diagram shown in FIG. 4a, except that action 101 is now replaced with an action 101.1. According to this flow diagram, in action 101.1 the navigation device 10 determines the current position based on information received from the positioning device 23 and/or may receive information about a route planned by navigation device 10. This may be a route planned and stored in the memory 12, 13, 14, 15. Of course, the route may also be a route that is currently being traveled.

This way, the user is informed about tasks that may be completed along the route or nearby a destination. According to this embodiment, the user may be informed about these tasks in advance, i.e. before the user actually comes close to the location indicator or even before the user has started his/her journey.

Of course, this embodiment may also be combined with other embodiments described, for instance with reference to FIG. 4b (threshold is travel distance D) and FIG. 6 (location indicators being POI categories).

If a user is planning a route to a city (e.g. Amsterdam), the user may be notified of an event taking place in that city. The navigation device 10 may for instance show a message informing the user of a certain event even before the user arrives in the city.

It will be understood that the embodiments described above are not restricted to navigation devices, but may be incorporated in any kind of computer system, such as a mobile computer system, a laptop, a PDA or a mobile telephone. The embodiments may be incorporated in any kind of navigation device 10, such as a handheld computer system, a built-in vehicle navigation device etc.

As already mentioned above, the navigation device 10 may also refer to a navigation device 10 not having a display 18. Such a navigation device 10 may for instance be used by persons with impaired vision. Being informed of POI's in the direct neighbourhood of the navigation device 10 may have a great advantage for such persons.

While specific embodiments of the invention have been described above, it will be appreciated that the invention may be practiced otherwise than as described. For example, the invention may take the form of a computer program containing one or more sequences of machine-readable instructions describing a method as disclosed above, or a data storage medium (e.g. semiconductor memory, magnetic or optical disk) having such a computer program stored therein. It will be understood by a skilled person that all software components may also be formed as hardware components.

The descriptions above are intended to be illustrative, not limiting. Thus, it will be apparent to one skilled in the art that modifications may be made to the invention as described without departing from the scope of the claims set out below.

1. Computer system, comprising:
a processor unit, arranged to communicate with a memory and a positioning device, the memory being including a map database and a task list, the task list including at least one task, wherein at least one of the at least one task includes a location indicator associated therewith, the positioning device being arranged to provide information about a position, wherein the computer system is arranged to
compute an estimated travel parameter from a current position as measured by the positioning device to a location indicator associated with one of the at least one task using the map database,
compare the computed estimated travel parameter to a threshold value, and
generate a warning signal if the computed estimated travel parameter is smaller than the threshold value.

2. Computer system according to claim 1, wherein the map database includes address information and points of interest, the points of interest being divided into POI categories.

3. Computer system according to claim 2, wherein in a case where the location indicator associated with a task is a POI category, the computer system is arranged to perform the computing of the estimated travel parameter by:
selecting a number of POFs from the map database from the POI category using a POI-selection algorithm,
computing estimated travel parameters from the current position to each of the selected POFs, and
selecting the POI of the number of POFs having the relatively smallest computed estimated travel parameter.

4. Computer system according to claim 1, wherein the estimated travel parameter is computed by computing a route from the current position to the location indicator using navigation software.

5. Computer system according to claim 4, wherein the estimated travel parameter is computed according to criteria.

6. Computer system according to claim 4, wherein the estimated travel parameter is computed taking into account current traffic information.

7. Computer system according to claim 1, wherein each of the at least one task includes a threshold value associated with therewith, and is performed by comparing the estimated travel parameter to the predetermined threshold value associated with the relevant task.

8. Computer system according to claim 1, wherein each task has a time associated with therewith.

9. Computer system according to claim 1, wherein the threshold value varies.

10. Computer system according to claim 8, wherein the threshold value varies depending on the time associated with the task.

11. Computer system according to claim 1, wherein the estimated travel parameter is one of an estimated travel time and an estimated travel distance.

12. Computer system according to claim 1, wherein the threshold value is one of a time threshold and a distance threshold.

13. Computer system according to claim 1, wherein the warning signal includes at least one of an acoustic warning signal, a spoken warning message and a warning signal provided using a speaker.

14. Computer system according to claim 1, wherein the warning signal is a warning icon displayed on a display.

15. Computer system according to claim 14, wherein the warning icon is a virtual button, which, when pressed, triggers the computer system to provide navigation instructions to navigate a user to the relevant location indicator.

16. Computer system according to claim 1, where the computer system includes at least one of a navigation device, a mobile telephone, a personal digital assistant, and a laptop.

17. Computer system according to claim 1, where the computer system is arranged to register completion of a task.

18. Computer system according to claim 1, wherein the computer system is a navigation device.

19. Vehicle, comprising a computer system according to claim 1.

20. Method, comprising:
providing a map database and a task list, the task list including at least one task, wherein at least one of the at least one task includes a location indicator associated therewith;
computing an estimated travel parameter from a current position, as measured by a positioning device, to a location indicator associated with one of the at least one tasks using the map database;
comparing the computed estimated travel parameter to a threshold value; and
generating a warning signal if the computed estimated travel parameter is smaller than the threshold value.

21. Computer program, when loaded on a computer arrangement, arranged to perform the method of claim 20.

22. Data carrier, comprising a computer program according to claim 21.

23. Computer system according to claim 2, wherein each location indicator is one of an address and POI category.

24. Computer system according to claim 11, wherein the threshold value is one of a time threshold and a distance threshold.

25. Computer system according to claim 1, further comprising the memory and the positioning device.
